(19) United States
(12) Patent Application Publication
(10) Pub. No.: US 2016/0060951 A1
(43) Pub. Date: Mar. 3, 2016

(54) METHOD AND APPARATUS FOR PROVIDING REFUGE PASSAGEWAYS

(71) Applicant: CHEMBIO SHELTER, INC., ALLENTOWN, PA (US)

(72) Inventor: Edward V. Roscioli, Easton, PA (US)

(21) Appl. No.: 14/839,217

(22) Filed: Aug. 28, 2015

Related U.S. Application Data
(60) Provisional application No. 62/043,075, filed on Aug. 28, 2014.

(51) Int. Cl. E06B 5/14

(52) U.S. Cl. CPC E06B 5/14

(57) ABSTRACT

A system and method for providing safe passageways in refuge walls such that the completed apparatus limits the infiltration of noxious and/or hazardous gasses in the atmosphere external to the refuge from entering the refuge during personnel ingress or egress, in which entry and exit can be accomplished without contaminating the refuge environment by way of flexible, conforming, rubber like sheeting, partially overlapped in single or multiple layers of varying directions, that will conform to occupants as they enter or leave the refuge or shelter.

### BACKGROUND

1. Field of the Invention

This invention relates to systems and devices for providing breathable air for shelters used to protect humans from unsafe atmospheres, such as those which are deficient in oxygen, or in which unsafe levels of carbon monoxide, methane, or other toxic chemicals, including toxic industrial chemicals or chemical, biological, or radiological warfare agents exist.

2. Description of the Related Art

Refuges, also known as shelters, safe havens, chambers and refuge alternatives are structures built into surface or subterranean spaces such that they provide a safe environment for occupants when the area outside the refuge presents hazards. In mining, such refuges are typically constructed of concrete blocks or poured concrete walls, although materials other than concrete can be used. Refuges can isolate a volume with the roof, any number of walls formed by the material not removed during mining. The atmosphere in the refuge is typically provided by prepositioned compressed oxygen and/or air or by use of oxygen generating chemical techniques, by cryogenic liquid air, or by boreholes allowing for the introduction of air from the surface.

When the refuge entry door is opened, ambient air with a higher noxious and/or hazardous gasses concentration will begin to move into the passageway. Significantly, as occupants move through the airlock they will expedite the turbulent diffusion (sometimes referred to as advective diffusion) of undesirable gases into the passageway. The level of these gases inside the passageway will continue to increase the noxious and/or hazardous gas concentration inside the passageway until the door is closed.

The current (prior) art for providing passageway through mine refuge walls provide either potential hazardous gas infiltration or limit their application to only those mines that suit their design.

### SUMMARY OF THE INVENTION

The invention taught herein provides for rapid installation, in conditions and with skills and materials typically found in a mine. While in use, the device of this invention limits infiltration of any noxious and/or hazardous gases that might be in the mine following an accident.

Accordingly, there is provided according to the invention a method and apparatus for providing refuge or shelter passageways that limit toxic gasses from entering the passageway when persons enter or leave the refuge or shelter, including flexible, conforming, rubber like sheeting, partially overlapped in single or multiple layers of varying directions, that will conform to occupants as they enter or leave the refuge or shelter. According to a preferred embodiment, the pieces of rubber like sheeting are stretched across a frame that fits in the perimeter of a passageway; wherein the pieces of rubber like sheeting are attached to the frame in a tight manner, such as stretching it and squeezing each end of said pieces between one frame part that is slightly larger around it's perimeter than a second frame part that fits inside the first part and traps the ends of the pieces of rubber like sheeting material between the two parts, and wherein the method of attaching the pieces of rubber like sheeting is selected from any method commonly known in the art, such as gluing, epoxying, welding with heat, welding with a third, typically melted, material or RF technology, ultrasonic technology, or hot air.

According to one embodiment, the rubber like sheeting is constructed of flexible silicone sheeting.

According to another embodiment, there are two pieces of rubber like sheeting that overlap each other.

According to a further embodiment, there are from 3 to 50 pieces of rubber like sheeting that overlap each other.

According to another embodiment, the pieces of rubber like sheeting overlap each other such that, when no objects are passing through the passageway, there are no openings in the sheeting.

According to another embodiment, the pieces of rubber like sheeting overlap each other such that, when a person or other object is pushed through the center of the passageway, the pieces of rubber like sheeting conform to the person or object by separating and allowing passage through the passageway, while limiting the amount of toxic gasses that enter the passageway.

According to another embodiment, the pieces of rubber like sheeting are from 0.020 inches to 0.400 inches thick, with the preferred embodiment being 0.080 inches thick.

According to another embodiment, the passageway is modular in design.

According to another embodiment, the modules of the passageway include an outer explosion proof door, the rubber like sheeting and frame, at least one modular passageway section, and an inner door section.

According to another embodiment, the space between the outer explosion proof door and the inner door comprises an airlock.

According to another embodiment, the airlock space is capable of being purged with air from pressurized cylinders of air.

According to another embodiment, the airlock space has a pressure relief valve.

According to another embodiment, the airlock space has a venture positioned in or directly adjacent to the pressure relief valve.

According to another embodiment, the airlock space has a venture air supply line.

According to another embodiment, the purge air supply line exhausts into the airlock space at a location opposite to the pressure relief valve and the pressure relief valve exhausts to the atmosphere exterior to the refuge or shelter.

The embodiments of the disclosure described herein are not intended to be exhaustive or to limit the disclosure to the precise forms disclosed. Rather, the embodiments selected for description have been chosen to enable one skilled in the art to practice the subject matter of the disclosure. Although the disclosure describes specific configurations providing passageway into a mine refuge, it should be understood that the concepts presented herein may be used in other various configurations consistent with this disclosure, in, for example, mobile mine refuges and shelters used to protect humans from unsafe atmospheres, such as those which are deficient in oxygen, or in which unsafe levels of carbon monoxide, methane, or other toxic chemicals, including toxic industrial chemicals or chemical, biological, or radiological warfare agents exist.

### BRIEF DESCRIPTION OF THE DRAWINGS

FIG. 1 is an illustration of a prior art door in frame.

FIG. 2 is an illustration of a prior art freestanding airlock.

FIG. 3 is an illustration of a refuge passageway according to an embodiment of the invention.

FIG. 4 is an illustration of the rubber like sheeting on an airlock door according to an embodiment of the invention.

FIG. 4B is an illustration of rubber like sheeting conforming to a person according to an embodiment of the invention.

FIG. 4C is an illustration of rubber like sheeting showing the area of overlap according to an embodiment of the invention.

FIG. 5 is an illustration of the passageway subcomponents according to an embodiment of the invention.

FIG. 6 is an illustration of the outer explosion proof passageway door according to an embodiment of the invention.

FIG. 7 shows further detail provided on the outer explosion proof passageway door shows according to an embodiment of the invention.

### DETAILED DESCRIPTION OF THE INVENTION

In the following detailed description, reference is made to the accompanying drawings which form a part hereof, and in which are shown by way of illustration preferred embodiments of the invention. These embodiments are described in sufficient detail to enable those skilled in the art to make and use them, and it is to be understood that structural, logical or procedural changes may be made.

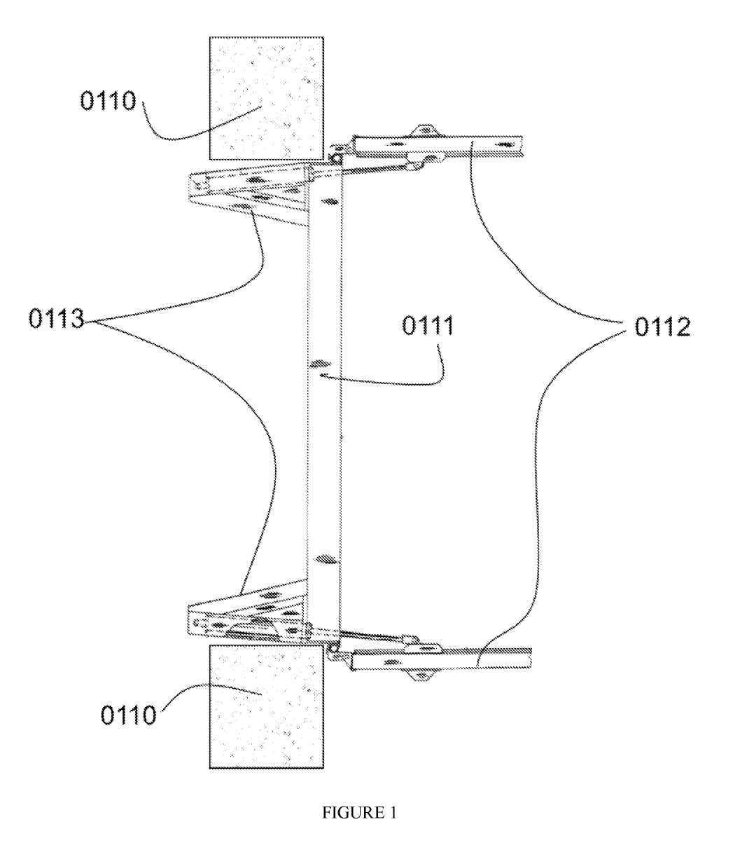

One type of prior art utilizes a simple door, either single or double, hung in a frame the latter of which is illustrated in FIG. 1. The door frame, numbered 0111, is affixed into a refuge wall, in this illustration a mine refuge, numbered 0110. The door can open either inwards or outwards with the latter being typical. A closing mechanism is sometimes provided as in 0112 of the illustration.

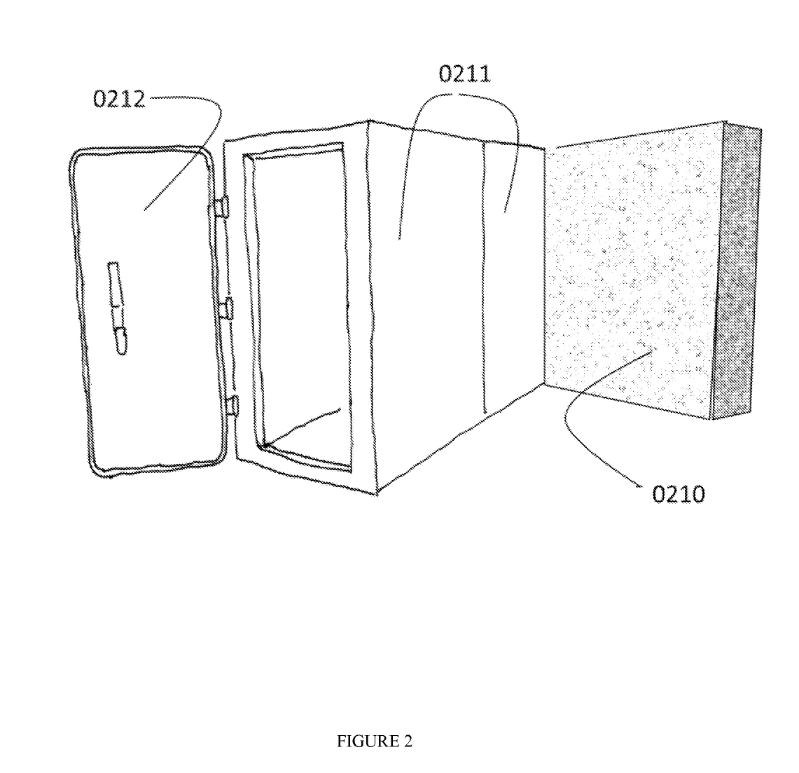

Referring now to FIG. 2, another example of the prior art, the passageway, numbered 0211, provides the ability to isolate the occupant during passage between two doors, number 0212, the outside door and another door (not shown) located adjacent to the refuge wall, numbered 0210, to which the entire apparatus is affixed. While this embodiment provides for safe passage, its configuration limits it use to mines with sufficient height and space.

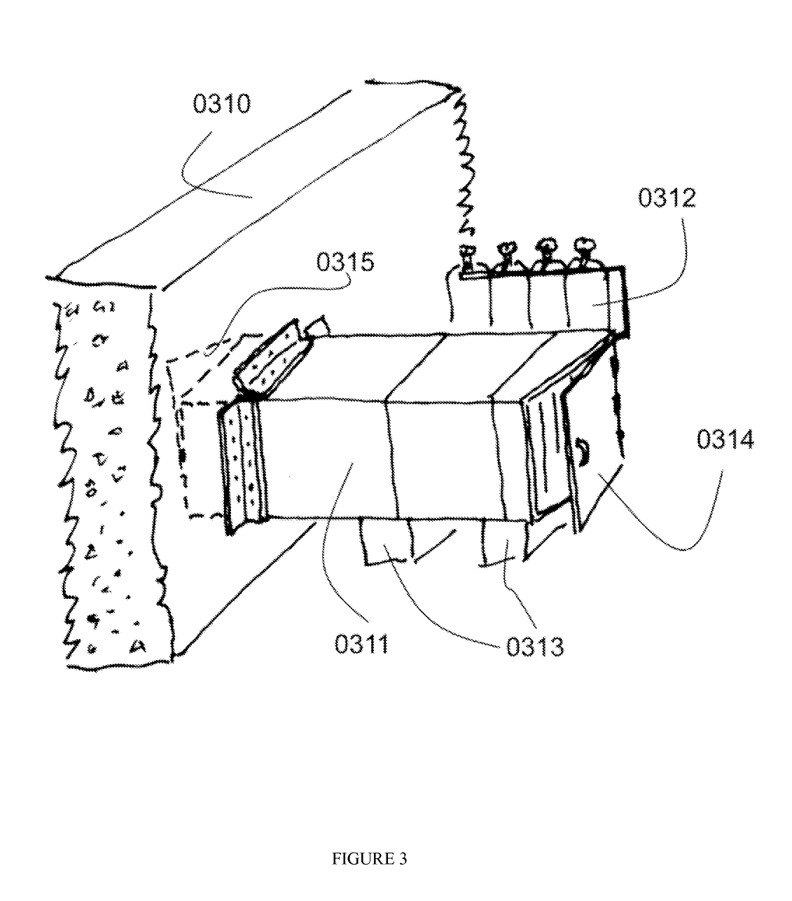

As shown in FIG. 3, various embodiments of the invention man provide a modular passageway that is adaptable to all mining conditions using skills and tools commonly available in the milieu of a mine and providing multiple options for minimizing advective diffusion. The assembled passageway, numbered 0311, passes through the refuge wall, numbered 0310, at the location and height desired, allowing for matching supports, numbered 0313. The embodiment of the invention illustrated in FIG. 3 allows for use of compressed air, numbered 0312, for purging the airlock.

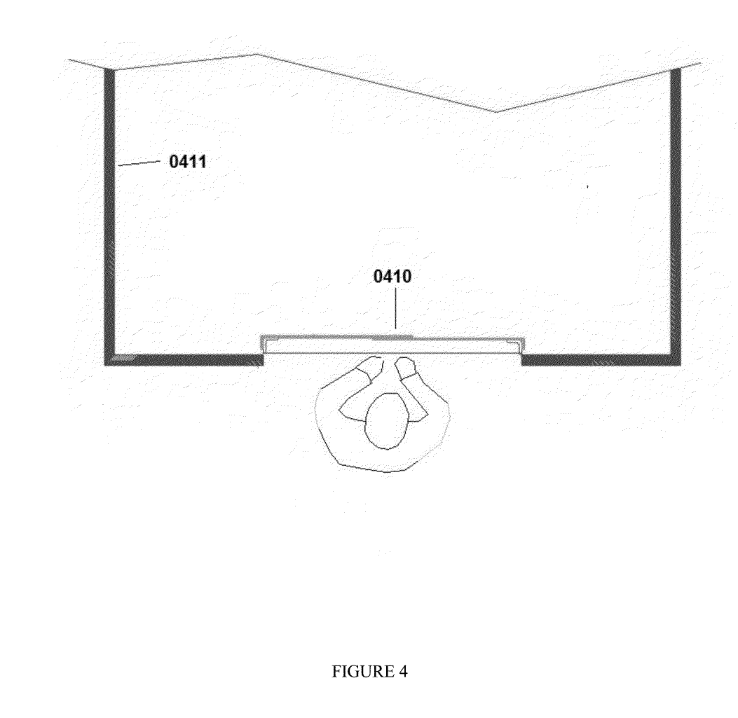

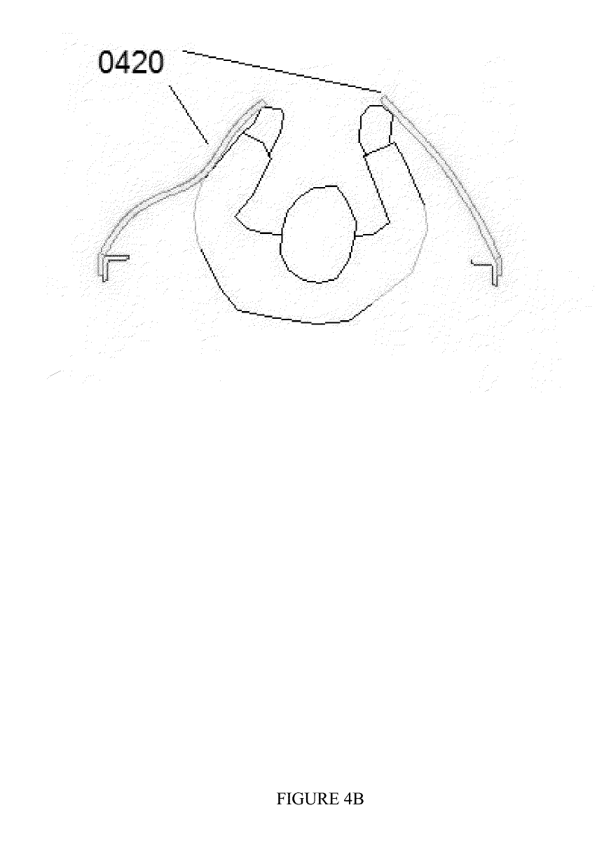

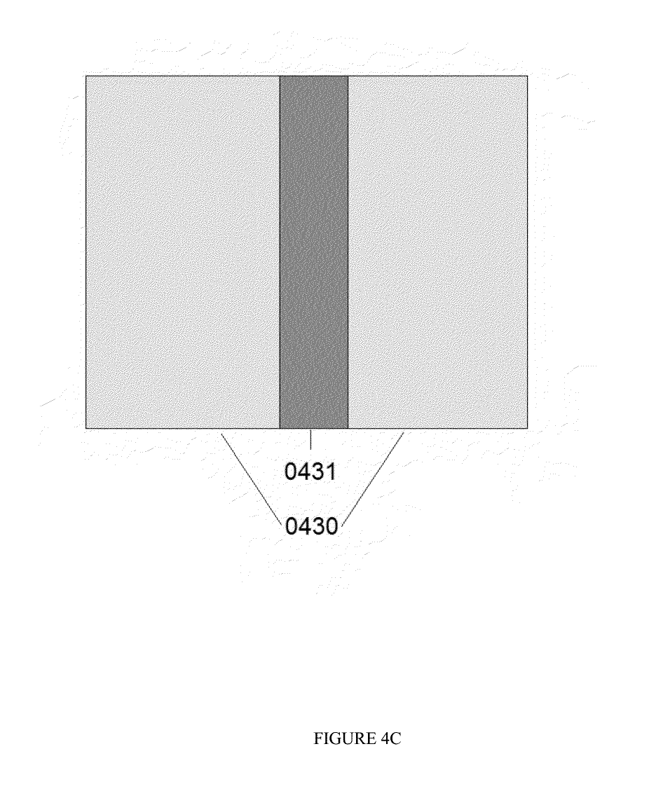

Referring now to FIG. 4, shown is a flexible conforming rubber like sheeting, number 0410, partially overlapped in single or multiple layers of varying directions, that will conform to occupants as they enter or leave the refuge. FIG. 4 shows an embodiment in which the refuge has an airlock, number 0411. The invention can also be used in a doorway without an airlock.

FIG. 4B shows the rubber like sheeting, number 0420, conforming to a person entering the refuge.

FIG. 4C shows the rubber like sheeting, number 0430, with 2 pieces of rubber like sheeting overlapping along a central vertical section, number 0431, from the top to the bottom of the opening.

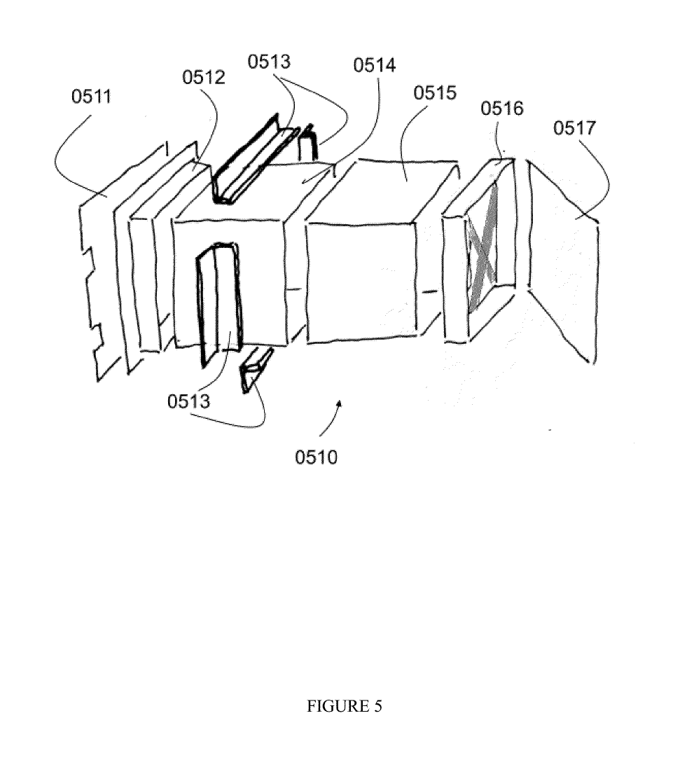

In FIG. 5 shows the modular subcomponents of a mine passageway, number 0510. Starting from the exterior is the explosion proof outer door, numbered 0511. This door fits into a heavy metal outer door frame, numbered 0512, which has predrilled holes for affixing to the refuge wall with appropriate anchors. There are four heavy steel inner collar plates, numbered 0513, also predrilled for affixing the inner side of the refuge wall and to the passageway. The first section of the passageway, number 0514, once affixed to the outer frame, number 0512, which in turn is affixed with bolts to the first passageway section, number 0514, is further secured to the inner refuge wall and the passageway section. This interconnection is critical as during an explosion there are two pressure waves. The first is a positive wave that exerts pressure on the outer door in the direction of the refuge. The second, followed in milliseconds, exerts a negative pressure away from the refuge. If the passageway is not properly secured, the outer door can be pulled from the refuge, rendering it inoperative. A second passageway section, numbered 0515, is secured to the first. The added length is necessary to accommodate an injured person on a backboard. In one such scenario one person would enter the passage way activating the purge air, while pulling the backboard bound person into the refuge. Only after that person was safely inside would they reenter, close the outer doors, deactivate the purge flow and exit the passageway. After the second passageway subsection is the rubber like barrier subsection, numbered 0516.

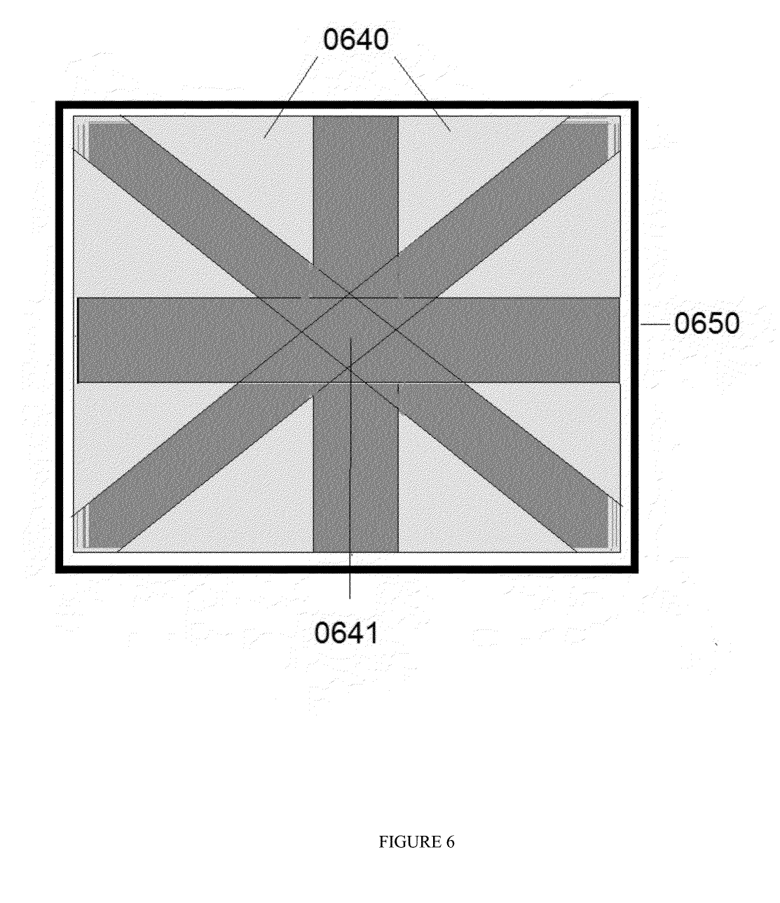

FIG. 6, the patent shows a preferred embodiment of inclusion of a rubber like barrier in the passageway. FIG. 6 shows the rubber like sheeting, number 0640, with 8 pieces of rubber like sheeting, all overlapping at the center of the opening, number 0641. The silicone and similar material, is unknown to the passageway art. The smooth overlapping silicone pieces, numbered 0640, are assembled in a frame, numbered 0650 and provide a barrier to the transfer of gases. Placing the rubber like barrier after the second passageway section and prior to the interior door provides an added level of protection. The rubber like barrier may be from 0.040 inches to 0.400 inches thick, with the preferred embodiment being 0.080 inches thick. The addition of this technique further enhances the protection afforded by the passageway's ability to purge any noxious and/or hazardous gasses prior to opening the interior passageway door.

According to a preferred embodiment, the pieces of rubber like sheeting are stretched across a frame that fits in the perimeter of a passageway; wherein the pieces of rubber like sheeting are attached to the frame in a tight manner, such as stretching it and squeezing each end of said pieces between one frame part that is slightly larger around it's perimeter than a second frame part that fits inside the first part and traps the ends of the pieces of rubber like sheeting material between the two parts. The method of attaching the pieces of rubber like sheeting may include any method commonly known in the art, such as gluing, epoxying, welding with heat, welding with a third, typically melted, material or RF technology, ultrasonic technology, or hot air.

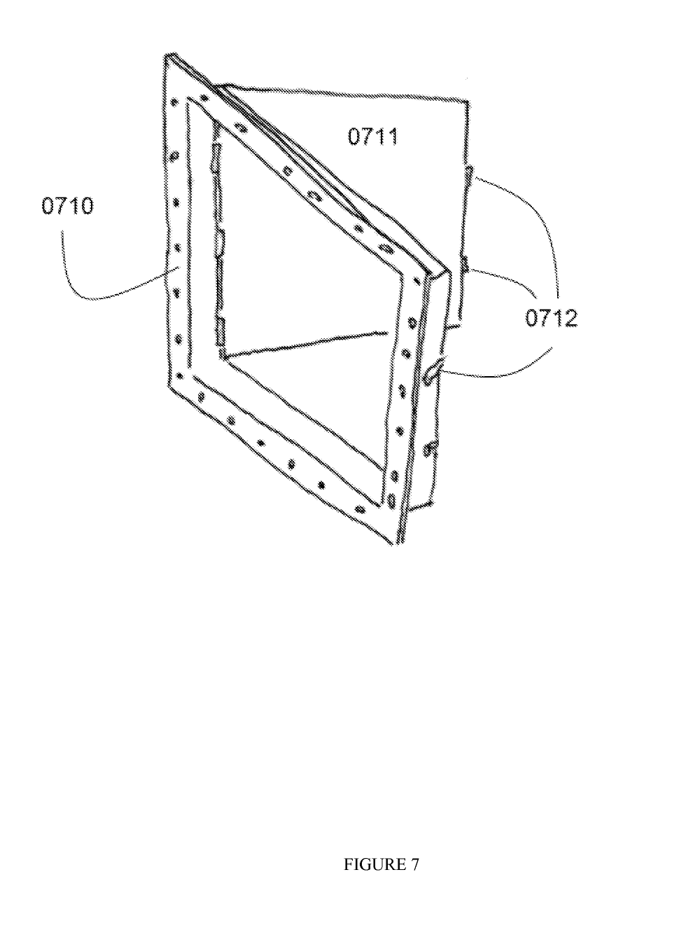

FIG. 7 illustrates the interior passageway door subcomponent. This subcomponent terminates the passageway and is affixed to the previous section by bolts in the predrilled frame, numbered 0710. The inner passageway door, numbered 0711, is hinged such that it opens into the refuge and closes with magnetic latches, numbered 0712. The magnetic latches are positioned to provide adequate compression on the gasket between the inner door and its frame, while allowing for opening when force is applied from an occupant traveling through the passageway.

1. A method and apparatus for providing refuge or shelter passageways that limit toxic gasses from entering the passageway when persons enter or leave the refuge or shelter, consisting of a flexible, conforming, rubber like sheeting, partially overlapped in single or multiple layers of varying directions, that will conform to occupants as they enter or leave the refuge or shelter.

2. The method and apparatus of claim 1 wherein the rubber like sheeting is constructed of flexible silicone sheeting.

3. The method and apparatus of claim 1 wherein there are two pieces of rubber like sheeting that overlap each other.

4. The method and apparatus of claim 1 wherein there are from 3 to 50 pieces of rubber like sheeting that overlap each other.

5. The method and apparatus of claim 1 wherein the pieces of rubber like sheeting are stretched across a frame that fits in the perimeter of a passageway; wherein the pieces of rubber like sheeting are attached to the frame in a tight manner, such as stretching it and squeezing each end of said pieces between one frame part that is slightly larger around it's perimeter than a second frame part that fits inside the first part and traps the ends of the pieces of rubber like sheeting material between the two parts, and wherein the method of attaching the pieces of rubber like sheeting is selected from any method commonly known in the art, such as gluing, epoxying, welding with heat, welding with a third, typically melted, material or RF technology, ultrasonic technology, or hot air.

6. The method and apparatus of claim 1 wherein the pieces of rubber like sheeting are initially in the shape of at least one of a rectangle, triangle, square, and any multisided shape, such as a pentagon, hexagon, octagon, etc.

7. The method and apparatus of claim 1 wherein the pieces of rubber like sheeting overlap each other, such that, when no objects are passing through the passageway, there are no openings in the sheeting.

8. The method and apparatus of claim 1 wherein the pieces of rubber like sheeting overlap each other such that, when a person or other object is pushed through the center of the passageway, the pieces of rubber like sheeting conform to the person or object by separating and allowing passage through the passageway, while limiting the amount of toxic gasses that enter the passageway.

9. The method and apparatus of claim 1 wherein the pieces of rubber like sheeting are from 0.020 inches to 0.400 inches thick, with the preferred embodiment being 0.080 inches thick.

10. The method and apparatus of claim 1 wherein the passageway is modular in design.

11. The method and apparatus of claim 1 wherein the modules of the passageway include an outer explosion proof door, the rubber like sheeting and frame, at least one modular passageway section, and an inner door section.

12. The method and apparatus of claim 9 wherein the space between the outer explosion proof door and the inner door comprises an airlock.

13. The method and apparatus of claim 10 wherein the airlock space is capable of being purged with air from pressurized cylinders of air.

14. The method and apparatus of claim 10 wherein the airlock space has a pressure relief valve.

15. The method and apparatus of claim 10 wherein the airlock space has a venture positioned in or directly adjacent to the pressure relief valve.

16. The method and apparatus of claim 10 wherein the airlock space has a venture air supply line.

17. The method and apparatus of claim 10 wherein purge air supply line.

18. The method and apparatus of claim 10 wherein the purge air supply line exhausts into the airlock space at a location opposite to the pressure relief valve. Said pressure relief valve exhausts to the atmosphere exterior to the refuge or shelter.
